(19) United States
(12) Patent Application Publication
(10) Pub. No.: US 2020/0358199 A1
(43) Pub. Date: Nov. 12, 2020

(54) METHOD FOR ARRANGEMENT OF LEAKY COAXIAL CABLES APPLIED TO STRIP-SHAPED ELONGATED AREA

(71) Applicant: JIANGSU HENGXIN TECHNOLOGY CO., LTD, Yixing City (CN)

(72) Inventors: ZhiXing YANG, Yixing City (CN); Zhonghua LIU, Yixing City (CN); Huiyi JIN, Yixing City (CN); Cenjia LV, Yixing City (CN); Guang WU, Yixing City (CN); Yongping SHI, Yixing City (CN); Bin CHEN, Yixing City (CN)

(21) Appl. No.: 16/497,246

(22) PCT Filed: Aug. 27, 2018
(86) PCT No.: PCT/CN2018/102434

§ 371 Date: Sep. 24, 2019

(30) Foreign Application Priority Data
Aug. 7, 2018 (CN) 201810892605.4

(51) Int. Cl. H01Q 13/20

(52) U.S. Cl. CPC H01Q 13/203

(57) ABSTRACT

A method for arrangement of leaky coaxial cables applied to a strip-shaped elongated area, includes: reducing a quantitative radiation performance of initial ends of the leaky coaxial cable combination structures of two areas symmetrically arranged with respect to a central area in a length direction of the strip-shaped elongated area to ensure a small transmission loss, on the premise of ensuring that a comprehensive loss of a link tail end of the leaky coaxial cable is constant; and reducing an appropriate transmission loss of tail ends of the leaky coaxial cable combination structures of the two areas at the central area to increase the radiation performance.

### CROSS REFERENCE TO RELATED APPLICATIONS

This application is a national stage application under 35 U.S.C. 371 of PCT Application No. PCT/CN2018/102434, Filed on 27 Aug. 2018, which PCT application claimed the benefit of Chinese Patent Application No. 2018108926054 filed on 7 Aug. 2018, the entire disclosure of each of which are hereby incorporated herein by reference.

### FIELD

The present disclosure relates to the technical field of arrangement of leaky coaxial cables, and in particular, to a method for arrangement of leaky coaxial cables applied to a strip-shaped elongated area.

### BACKGROUND

In strip-shaped elongated areas such as tunnels, pipe galleries, and mines, wireless communication is set up generally by using leaky coaxial cables. The radiation field intensity of the leaky coaxial cables is uniform and is not affected by factors such as tunnel curvature and slope. In the prior art, when leaky coaxial cables are arranged in an elongated area, the leaky coaxial cables are respectively connected, by means of jumpers located in a central area in the length direction of the elongated area, to leaky coaxial cables symmetrically arranged at both sides. The grooving parameters of outer conductors of two symmetrically-arranged leaky coaxial cables are identical. The jumper is generally short (1-2 m) and only plays a role of jumping. Since the transmission loss of the leaky coaxial cable is increased with the coverage radius, the general coverage radius is designed due to considerations of the “end field intensity+engineering margin”, so that the field intensity of the initial end of the leaky coaxial cable is strong, resulting in waste. Moreover, since a 100-meter loss constant of the leaky coaxial cable is low, a long switching area is required to meet switching conditions during the tail end switching. Due to engineering margin considerations, the situation in which the switching is not timely and switching cannot be performed normally also often occurs in the tail end switching area, which requires subsequent improvement and solution through other measures. Moreover, this situation is often accompanied by a low signal-to-noise ratio, thereby affecting the communication quality. Especially with the development of a Multiple-Input Multiple-Output (MIMO) technology, the application of the leaky coaxial cable-based MIMO technology is more and more widely used. If a high signal-to-noise ratio cannot be guaranteed at the tail end of the leaky coaxial cable, the MIMO effect will be severely affected, or even the MIMO effect cannot be achieved at all. In this case, the communication effect is not even as good as that of a Single-Input Single-Output (SISO) system.

In summary, in the existing method for arrangement of leaky coaxial cables applied to a strip-shaped elongated area, the leaky coaxial cables symmetrically arranged at both sides are connected respectively by means of jumpers located in a central area in the length direction of an elongated area, and grooving parameters of outer conductors of the two symmetrically-arranged leaky coaxial cables are identical, where the length of the jumper is generally short (1-2 m) and only plays the role of jumping. The defects are as follows: excessive field intensity at the initial end of the leaky coaxial cable, too long tail end switching area, poor switching effect, and low signal-to-noise ratio.

### SUMMARY

Regarding the aforementioned problem, the present disclosure provides a method for arrangement of leaky coaxial cables applied to a strip-shaped elongated area, which can avoid waste of the field intensity at an initial end of a leaky coaxial cable, improve a signal-to-noise ratio of an end signal coverage area, shorten a signal switching area, stabilize a switching effect, and achieve an objective of smooth switching.

The method for arrangement of leaky coaxial cables applied to a strip-shaped elongated area includes: for leaky coaxial cable combination structures of two areas symmetrically arranged with respect to a central area in a length direction of the strip-shaped elongated area, reducing a quantitative radiation performance of initial ends of the leaky coaxial cable combination structures of the two areas relatively far from the central area to ensure a small transmission loss, on the premise of ensuring that a comprehensive loss of a link tail end of the leaky coaxial cable is constant; and reducing an appropriate transmission loss of tail ends of the leaky coaxial cable combination structures of the two areas at the central area to increase the radiation performance.

The method is further characterized as follows.

Each of the leaky coaxial cable combination structures includes a breakpoint-free leaky coaxial cable and a half jumper, where the half jumpers of the leaky coaxial cable combination structures of the two areas are combined to form an integral jumper. Both ends of the jumper in the length direction are respectively connected to tail ends of corresponding leaky coaxial cables located at the both ends, initial ends of two of the leaky coaxial cables are located at both ends of the strip-shaped elongated area in the length directions. A groove hole on each of the breakpoint-free leaky coaxial cables has at least two different groove hole parameters, and the groove hole parameters include, but are not limited to, a groove hole shape, a gradient pitch, a groove width, a groove length, a grooving dip angle, a hole spacing, and a combined groove hole pattern.

The groove hole shape includes, but is not limited to, a splayed shape, a U shape, a vertical strip shape, or an inclined strip shape.

Each of the breakpoint-free leaky coaxial cables includes groove holes having at least two pitches; a groove group composed of groove holes with a large pitch is disposed at the initial end of the leaky coaxial cable, and a groove group composed of groove holes with a small pitch is disposed at the tail end of the leaky coaxial cable.

Each of the breakpoint-free leaky coaxial cables includes groove holes having at least two groove lengths, wherein a groove group composed of groove holes with a relatively small groove length is disposed at the initial end of the leaky coaxial cable, and a groove group composed of groove holes with a relatively large groove length is disposed at the tail end of the leaky coaxial cable.

Each of the breakpoint-free leaky coaxial cables includes groove holes having at least two groove widths; a groove group composed of groove holes with a relatively small groove width is disposed at the initial end of the leaky coaxial cable, and a groove group composed of groove holes with a relatively large groove width is disposed at the tail end of the leaky coaxial cable.

Each of the breakpoint-free leaky coaxial cables includes groove holes having two grooving dip angles between the groove hole of the splayed groove hole close to the initial end and a central axis. A groove group composed of groove holes with a relatively small grooving dip angle is disposed at the initial end of the leaky coaxial cable, and a groove group composed of groove holes with a relatively large grooving dip angle is disposed at the tail end of the leaky coaxial cable.

Each of the breakpoint-free leaky coaxial cables has at least two grooving shapes. The grooving shapes include a splayed shape and a U shape. A groove group with a good transmission performance is disposed at the initial end of the leaky coaxial cable, and a groove group with a good radiation performance is disposed at the tail end of the leaky coaxial cable.

In an implementation, one breakpoint-free leaky coaxial cable is provided with at least two groups of gradient groove holes, including, but not limited to, the above-mentioned five modes used separately or in combination. When the above-mentioned five modes are combined, the modes need to be arranged according to the above-mentioned rules, and the more the number of grooving groups is, the smoother the compressive loss transition is. For specific grooving parameters, reference is made to the performance of the leaky coaxial cable when the respective grooving parameters exist separately.

Each of the leaky coaxial cable combination structures includes a first leaky coaxial cable, a transition jumper, and a half second leaky coaxial cable, wherein the half second leaky coaxial cables of the leaky coaxial cable combination structures of the two areas are combined to form an integral second leaky coaxial cable, and both ends of the second leaky coaxial cable in the length direction are respectively connected to inner ends of the corresponding transition jumpers at both ends. Outer ends of each of the transition jumpers are respectively connected to the tail ends of the first leaky coaxial cable, and initial ends of two of the first leaky coaxial cables are located at both ends of the strip-shaped elongated area in the length direction.

The specification of the second leaky coaxial cable is smaller than that of the first leaky coaxial cable. The groove hole parameters of the first leaky coaxial cable and second leaky coaxial cable are the same, and the second leaky coaxial cable with a smaller specification is selected according to a design margin for switching, so as to achieve an objective of smoothly increasing an end transmission loss and shortening a switching area. Moreover, due to the same groove hole parameters, the second leaky coaxial cable of the small specification and the first leaky coaxial cable at the front end have the same radiation characteristics, and only the transmission loss is correspondingly increased. The second leaky coaxial cable of the small specification in this solution is generally cheaper, which is advantageous for cost saving. When applied with a large level margin, the second leaky coaxial cable not only makes the switching smoother, but also improves the signal-to-noise ratio of an end area.

Each of the leaky coaxial cable combination structures includes a first leaky coaxial cable, a transition jumper, and a half second leaky coaxial cable, wherein the half second leaky coaxial cables of the leaky coaxial cable combination structures of the two areas are combined to form an integral second leaky coaxial cable, and both ends of the second leaky coaxial cable in the length direction are respectively connected to inner ends of the corresponding transition jumpers at both ends; outer ends of each of the transition jumpers are respectively connected to the tail ends of the first leaky coaxial cable, and initial ends of two of the first leaky coaxial cables are located at both ends of the strip-shaped elongated area in the length direction.

The specification of the second leaky coaxial cable and the specification of the first leaky coaxial cable are the same, and the groove hole parameters of the first leaky coaxial cable and second leaky coaxial cable are different. The first leaky coaxial cable is an initial end of the leaky coaxial cable combination structure, and any half second leaky coaxial cable of each of the second leaky coaxial cables is a tail end of the leaky coaxial cable combination structure of the corresponding area. A low attenuation leaky coaxial cable is used as the first cable, and a high radiation leaky coaxial cable is used as the second cable, so that the overall end field intensity is consistent with the designed end field intensity, and the objectives of smoothening a comprehensive loss of the leaky coaxial cable, improving the signal-to-noise ratio of an end coverage area and shortening a switching area are achieved. The flexibility is high, and the effect is good.

After the method according to the present disclosure is adopted, for leaky coaxial cable combination structures of two areas symmetrically arranged with respect to a central area in a length direction of the strip-shaped elongated area, on the premise of ensuring that a comprehensive loss of a link tail end of the leaky coaxial cable is constant. Initial ends of the leaky coaxial cable combination structures of the two areas relatively far from the central area help to reduce a quantitative radiation performance to ensure a small transmission loss, and tail ends of the leaky coaxial cable combination structures of the two areas at the central area help to reduce an appropriate transmission loss to increase the radiation performance. The method can avoid waste of the field intensity of the initial end of the leaky coaxial cable, improve the signal-to-noise ratio of the end signal coverage area, shorten the signal switching area, stabilize a switching effect, and achieve an objective of smooth switching.

### BRIEF DESCRIPTION OF THE DRAWINGS

FIG. 1 shows a schematic view of an existing arrangement of leaky coaxial cables;

FIG. 2 shows a structural arrangement view in a first solution of the present disclosure;

FIG. 3 shows a structural arrangement view in a second solution of the present disclosure;

FIG. 4 shows a structural arrangement view in a third solution of the present disclosure;

FIG. 5 shows a schematic arrangement view of groove holes of a leaky coaxial cable according to a first embodiment in the first solution of the present disclosure;

FIG. 6 shows a schematic arrangement view of groove holes of a leaky coaxial cable according to a second embodiment in the first solution of the present disclosure;

FIG. 7 shows a schematic arrangement view of groove holes of a leaky coaxial cable according to a third embodiment in the first solution of the present disclosure;

FIG. 8 shows a schematic arrangement view of groove holes of a leaky coaxial cable according to a fourth embodiment in the first solution of the present disclosure;

FIG. 9 shows a schematic arrangement view of groove holes of a leaky coaxial cable according to a fifth embodiment in the first solution of the present disclosure;

FIG. 10 shows a structural arrangement view of a specific application embodiment of the present disclosure;

FIG. 11 shows a schematic view of a signal field intensity using a conventional coverage mode in an A-B interval of FIG. 10; and

FIG. 12 shows a schematic view of a signal field intensity after the first solution is used in the A-B interval of FIG. 10.

### DETAILED DESCRIPTION

A method for arrangement of leaky coaxial cables applied to a strip-shaped elongated area includes: for leaky coaxial cable combination structures of two areas symmetrically arranged with respect to a central area in a length direction of the strip-shaped elongated area, on the premise of ensuring that a comprehensive loss of a link tail end of the leaky coaxial cable is constant, reducing a quantitative radiation performance of initial ends of the leaky coaxial cable combination structures of the two areas relatively far from the central area to ensure a small transmission loss, and reducing an appropriate transmission loss of tail ends of the leaky coaxial cable combination structures of the two areas at the central area to increase the radiation performance.

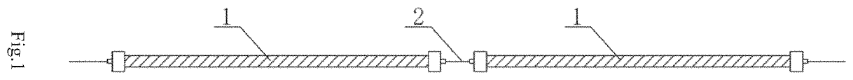

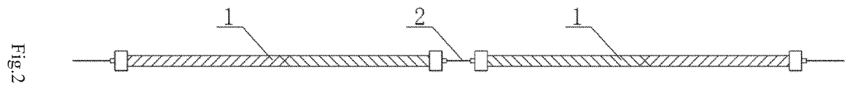

In the first solution, referring to FIGS. 1 and 2, each leaky coaxial cable combination structure includes a breakpoint-free leaky coaxial cable 1 and a half jumper, wherein the half jumpers of the leaky coaxial cable combination structures of the two areas are combined to form an integral jumper 2. Both ends of the jumper in the length direction 2 are respectively connected to tail ends of corresponding leaky coaxial cables 1 located at the both ends, initial ends of two leaky coaxial cables 1 are located at both ends of the strip-shaped elongated area in the length directions. A groove hole on each of the breakpoint-free leaky coaxial cables 1 has at least two different groove hole parameters. The groove hole parameters include, but are not limited to, a groove hole shape, a gradient pitch, a groove width, a groove length, a grooving dip angle, a hole spacing, and a combined groove hole pattern.

The groove hole shape includes, but is not limited to, a splayed shape, a U shape, a vertical strip shape, or an inclined strip shape.

In the first embodiment, referring to FIG. 5, each breakpoint-free leaky coaxial cables includes groove holes having two pitches, wherein a groove group composed of groove holes with a large pitch P1 is disposed at the initial end of the leaky coaxial cable, and a groove group composed of groove holes with a small pitch P2 is disposed at the tail end of the leaky coaxial cable.

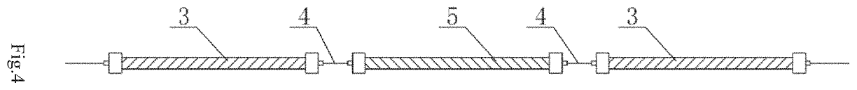

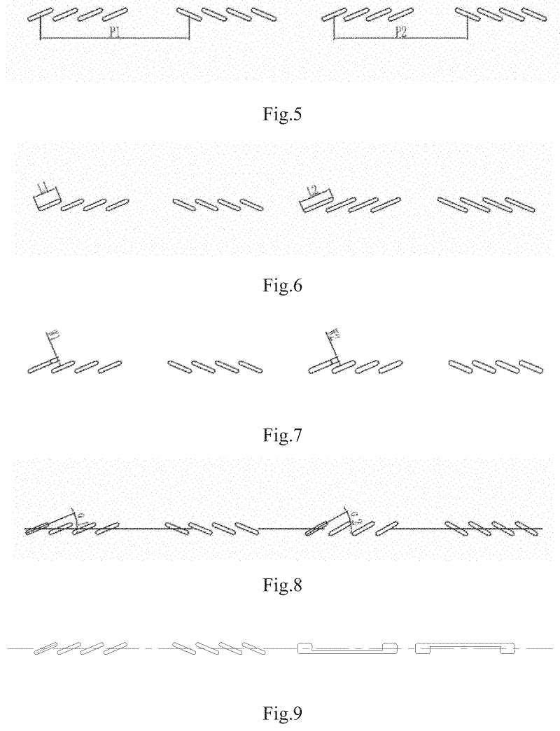

In the second embodiment, referring to FIG. 6, each breakpoint-free leaky coaxial cable includes groove holes having two groove lengths, wherein a groove group composed of groove holes with a relatively small groove length L1 is disposed at the initial end of the leaky coaxial cable, and a groove group composed of groove holes with a relatively large groove length L2 is disposed at the tail end of the leaky coaxial cable.

In the third embodiment, referring to FIG. 7, each breakpoint-free leaky coaxial cable includes groove holes having two groove widths, wherein a groove group composed of groove holes with a relatively small groove width W1 is disposed at the initial end of the leaky coaxial cable, and a groove group composed of groove holes with a relatively large groove width W2 is disposed at the tail end of the leaky coaxial cable.

In the fourth embodiment, referring to FIG. 8, when the groove hole shape is a splayed shape, each breakpoint-free leaky coaxial cable includes groove holes having two grooving dip angles that are angles between the groove hole of the splayed groove hole close to the initial end and a central axis. A groove group composed of groove holes with a relatively small grooving dip angle α1 is disposed at the initial end of the leaky coaxial cable, and a groove group composed of groove holes with a relatively large grooving dip angle α2 is disposed at the tail end of the leaky coaxial cable.

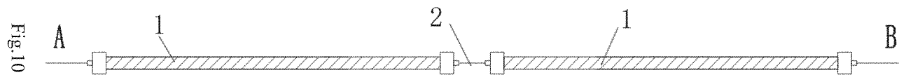

In the fifth embodiment, referring to FIG. 9, when the leaky coaxial cable is laid in the horizontal direction, and the main polarization mode is required to be vertical polarization, each of the breakpoint-free leaky coaxial cables has two grooving shapes including a splayed shape and a U shape. A groove group with a good transmission performance is disposed at the initial end of the leaky coaxial cable, and a groove group with a good radiation performance is disposed at the tail end of the leaky coaxial cable.

In an embodiment, one breakpoint-free leaky coaxial cable is provided with at least two groups of gradient groove holes, including, but not limited to, the above-mentioned five modes used separately or in combination. When the above-mentioned five modes are combined, the modes need to be arranged according to the above-mentioned rules, and the more the number of grooving groups is, the smoother the compressive loss transition is. For specific grooving parameters, reference is made to the performance of the leaky coaxial cable when the respective grooving parameters exist separately.

In the second and third solutions, each leaky coaxial cable combination structure includes a first leaky coaxial cable 3, a transition jumper 4, and a half second leaky coaxial cable, where the half second leaky coaxial cables of the leaky coaxial cable combination structures of the two areas are combined to form an integral second leaky coaxial cable 5, and both ends of the second leaky coaxial cable 5 in the length direction are respectively connected to inner ends of the corresponding transition jumpers 4 at both ends. Outer ends of each of the transition jumpers 4 are respectively connected to the tail ends of the first leaky coaxial cable 3, and initial ends of two first leaky coaxial cables 3 are located at both ends of the strip-shaped elongated area in the length direction.

In the second solution, referring to FIG. 3, the specification of the second leaky coaxial cable 5 is smaller than that of the first leaky coaxial cable 3, groove hole parameters of the first leaky coaxial cable 3 and the second leaky coaxial cable 5 are the same, and the second leaky coaxial cable 5 with a smaller specification is selected according to a design margin for switching, so as to achieve an objective of smoothly increasing an end transmission loss and shortening a switching area. Moreover, due to the same groove hole parameters, the second leaky coaxial cable of the small specification and the first leaky coaxial cable at the front end have the same radiation characteristics, and only the transmission loss is correspondingly increased. The second leaky coaxial cable of the small specification in this solution is generally cheaper, which is advantageous for cost saving. When applied with a large level margin, the second leaky coaxial cable not only makes the switching smoother, but also improves the signal-to-noise ratio of an end area.

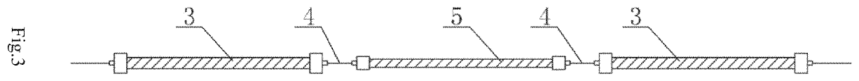

In third solution, referring to FIG. 4, the specification of the second leaky coaxial cable 5 and the specification of the first leaky coaxial cable 3 are the same, and the groove hole parameters of the first leaky coaxial cable 3 and second leaky coaxial cable 5 are different. The groove hole parameters include, but are not limited to, a groove hole shape, a gradient pitch, a groove width, a groove length, a grooving dip angle, a hole spacing, and a combined groove hole pattern. The groove hole shape includes, but is not limited to, a splayed shape, a U shape, a vertical strip shape, or an inclined strip shape. The first leaky coaxial cable is an initial end of the leaky coaxial cable combination structure, and any half second leaky coaxial cable of each of the second leaky coaxial cables 5 is a tail end of the leaky coaxial cable combination structure of the corresponding area. The first cable 3 uses a low attenuation leaky coaxial cable, and the second cable 5 uses a high radiation leaky coaxial cable, so that the overall end field intensity is consistent with the designed end field intensity, and the objectives of smoothening a comprehensive loss of the leaky coaxial cable, improving the signal-to-noise ratio of an end coverage area and shortening a switching area are achieved. The flexibility is high, and the effect is good.

In an embodiment, referring to FIG. 10, in a certain LTE 1.8G system built by a leaky coaxial cable, a cell A is spaced apart from a cell B by 1.2 km, and two leaky coaxial cables which are each 600 m long are connected by means of a jumper. Provided that switching is performed at the 600 m position in the middle of the A-B interval (refer to relative signal strength criteria with threshold specifications), the designed switching trigger condition is: RSRP trigger threshold <−100 dBm, and the signal difference between cells A and B is 6 dB. A leaky coaxial cable using the conventional coverage mode has an attenuation constant of 3.8 dB/hm and a coupling loss of 65 dB (95%, 2 m). The parameters of the leaky coaxial cable set by using the first solution are: 3.6 dB/hm, 68 dB & 5.6 dB/hm, 60 dB.

A schematic view of the signal field intensity of the A-B interval in the conventional coverage mode is shown in FIG. 11. Calculated according to a switching threshold, the length of this area from the satisfaction of <−100 dBm to the satisfaction of the signal difference of 6 dB is L=6/(3.8*2)≈0.79 hm, namely 79 m. In the area of about 160 m (520-680 m) of the switching area (switching from A to B or switching from B to A) (in this case, a switching area extension resulting from the switching time*the moving speed of a mobile station, about 10 m, is neglected), the Signal-to-Noise Ratio (SNR)<6 dB, and after the switching is completed, the SNR will be greater than 6 dB.

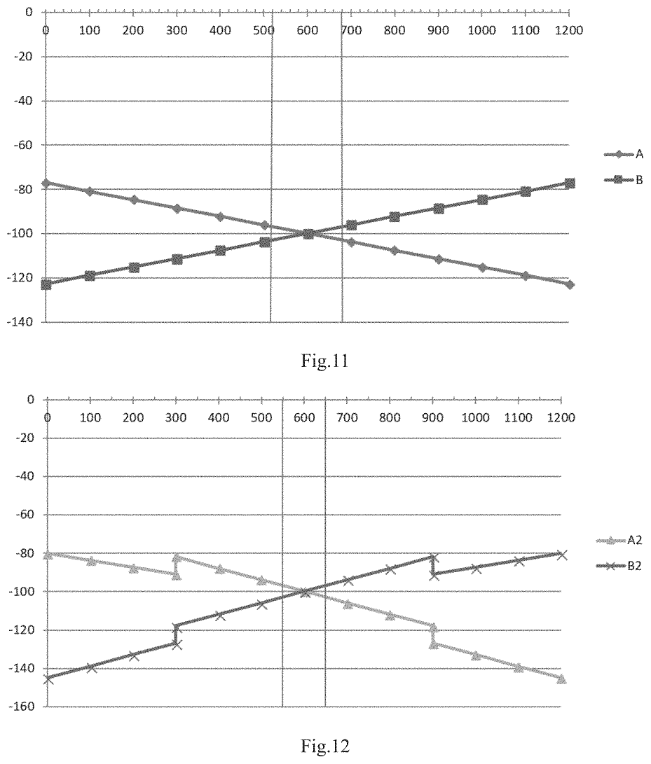

A schematic view of the signal field intensity of the A-B interval in the coverage mode of this solution is shown in FIG. 12. Calculated according to a switching threshold, the length of this area from the satisfaction of <−100 dBm to the satisfaction of the signal difference of 6 dB is L=6/(6*2)=0.5 hm, namely 50 m. In the area of about 100 m (550-650 m) of the switching area (in this case, a switching area extension resulting from the switching time*the moving speed of a mobile station, about 10 m, is neglected), the SNR<6 dB, and after the switching is completed, the SNR will be greater than 6 dB. Relatively speaking, the switching area of the coverage mode of this solution is shortened by about 160-100=60 m compared with the conventional coverage mode, and the SNR is greater than 6 dB in the 60 m area.

The three solutions can be used to solve the problems of excessive field intensity at the initial end of the leaky coaxial cable, too long end switching area, poor switching effect and low signal-to-noise ratio, and can be selected specifically according to actual application scenarios and functional requirements. This solution has guiding significance for the effective application of the leaky coaxial cable in long-distance laying (the information source equipment spacing >200 m) and the application of a leaky coaxial cable-based MIMO solution.

The specific embodiments of the present disclosure have been described in detail above, but the contents are only preferred embodiments of the present disclosure and cannot be considered as limiting the implementation scope of the present disclosure. Any equivalent changes and improvements made in accordance with the application scope of the present disclosure shall still fall within the scope of this patent.

1. A method for arrangement of leaky coaxial cables applied to a strip-shaped elongated area, comprising:
reducing a quantitative radiation performance of initial ends of the leaky coaxial cable combination structures of two areas symmetrically arranged with respect to a central area in a length direction of the strip-shaped elongated area to ensure a small transmission loss, on the premise of ensuring that a comprehensive loss of a link tail end of the leaky coaxial cable is constant; and
reducing an appropriate transmission loss of tail ends of the leaky coaxial cable combination structures of the two areas at the central area to increase the radiation performance.

2. The method according to claim 1, wherein:
each of the leaky coaxial cable combination structures comprises a breakpoint-free leaky coaxial cable and a half jumper;
the half jumpers of the leaky coaxial cable combination structures of the two areas are combined to form an integral jumper;
both ends of the jumper in the length direction are respectively connected to tail ends of corresponding leaky coaxial cables located at the both ends, and initial ends of two of the leaky coaxial cables are located at both ends of the strip-shaped elongated area in the length directions;
a groove hole on each of the breakpoint-free leaky coaxial cables has at least two different groove hole parameters; and
the groove hole parameters comprise a groove hole shape, a gradient pitch, a groove width, a groove length, a grooving dip angle, a hole spacing, and a combined groove hole pattern.

3. The method according to claim 2, wherein the groove hole shape comprises, but is not limited to, a splayed shape, a U shape, a vertical strip shape, or an inclined strip shape.

4. The according to claim 2, wherein:
each of the breakpoint-free leaky coaxial cables comprises groove holes having at least two pitches;
a groove group composed of groove holes with a large pitch is disposed at the initial end of the leaky coaxial cable; and
a groove group composed of groove holes with a small pitch is disposed at the tail end of the leaky coaxial cable.

5. The method according to claim 2, wherein:
each of the breakpoint-free leaky coaxial cables comprises groove holes having at least two groove lengths;
a groove group composed of groove holes with a relatively small groove length is disposed at the initial end of the leaky coaxial cable; and
a groove group composed of groove holes with a relatively large groove length is disposed at the tail end of the leaky coaxial cable.

6. The method according to claim 2, wherein:
each of the breakpoint-free leaky coaxial cables comprises groove holes having at least two groove widths;
a groove group composed of groove holes with a relatively small groove width is disposed at the initial end of the leaky coaxial cable; and
a groove group composed of groove holes with a relatively large groove width is disposed at the tail end of the leaky coaxial cable.

7. The method according to claim 2, wherein:
each of the breakpoint-free leaky coaxial cables comprises groove holes having two grooving dip angles being between the groove hole of the splayed groove hole close to the initial end and a central axis;
a groove group composed of groove holes with a relatively small grooving dip angle is disposed at the initial end of the leaky coaxial cable; and
a groove group composed of groove holes with a relatively large grooving dip angle is disposed at the tail end of the leaky coaxial cable.

8. The method according to claim 1, wherein:
each of the leaky coaxial cable combination structures comprises a first leaky coaxial cable, a transition jumper, and a half second leaky coaxial cable;
the half second leaky coaxial cables of the leaky coaxial cable combination structures of the two areas are combined to form an integral second leaky coaxial cable;
both ends of the second leaky coaxial cable in the length direction are respectively connected to inner ends of the corresponding transition jumpers at both ends;
outer ends of each of the transition jumpers are respectively connected to the tail ends of the first leaky coaxial cable; and
initial ends of two of the first leaky coaxial cables are located at both ends of the strip-shaped elongated area in the length direction.

9. The method according to claim 8, wherein:
the specification of the second leaky coaxial cable is smaller than that of the first leaky coaxial cable;
the groove hole parameters of the first leaky coaxial cable and second leaky coaxial cable are the same; and
the second leaky coaxial cable with a smaller specification is selected according to a design margin for switching, to achieve an objective of smoothly increasing an end transmission loss and shortening a switching area.

10. The method according to claim 8, wherein:
the specification of the second leaky coaxial cable and the specification of the first leaky coaxial cable are the same;
the groove hole parameters of the first leaky coaxial cable and second leaky coaxial cable are different;
the first leaky coaxial cable is an initial end of the leaky coaxial cable combination structure;
any half second leaky coaxial cable of each of the second leaky coaxial cables is a tail end of the leaky coaxial cable combination structure of the corresponding area; and
a low attenuation leaky coaxial cable is used as the first cable, and a high radiation leaky coaxial cable is used as the second cable.
